(19) United States
(12) Patent Application Publication
(10) Pub. No.: US 2012/0118861 A1
(43) Pub. Date: May 17, 2012

(54) Method and Control Device for Monitoring the Quality of Spot Welds of a Resistance Welding Gun Comprising the Outputting of a Warning Message

(75) Inventors: Juergen Haeufgloeckner, Schneeberg (DE); Michael Ripper, Beerfurth (DE); Denis Court, Schorndorf (DE); Klaus Ehrhardt, Nufringen (DE); Norbert Kramer, Entingen (DE); Micha Bertsch, Holzgerlingen (DE)

(73) Assignee: Robert Bosch GmbH, Stuttgart (DE)

(21) Appl. No.: 13/263,147

(22) PCT Filed: Mar. 26, 2010
(86) PCT No.: PCT/EP2010/001904

§ 371 Date: Feb. 1, 2012

(30) Foreign Application Priority Data
Apr. 7, 2009 (DE) 10 2009 016 798.6

(51) Int. Cl. B23K 11/11

(52) U.S. Cl. 219/91.1

(57) ABSTRACT

A method for monitoring and/or regulating the quality of spot welds of a resistance welding gun includes measuring and storing measured values during the execution of resistance spot welds at different points on a workpiece. The measured values represent a voltage, a current, a resistance, a welding time, an energy, a force on welding contacts and/or an output during the production of a resistance spot weld. The method also includes comparing the measured values with a reference measurement value. The reference measurement value represents a corresponding voltage, a current, a resistance, a welding time, an energy, a force on welding contacts and/or an output during the production of a corresponding resistance spot weld. The method also includes outputting a warning message when, during the comparison, it is established that a predetermined number of successive measured values is outside a predefined tolerance band from the reference measurement value.

The present invention is concerned with a method for monitoring and/or regulating the quality of spot welds of a resistance welding gun in accordance with claim 1, and a control device for monitoring and/or regulating the quality of spot welds of a resistance welding gun in accordance with claim 10.

Modern manufacturing plants, for example for motor vehicles, use automated welding for joining metallic components, in particular metal sheets. In this case, a continuous welding seam is not produced, rather individual spot welds are applied, by means of a resistance welding gun, to the metallic components to be welded. However, conventional manufacturing plants permit only poor monitoring of the quality of the spot welds produced, since only a predefined welding current is applied to the welding guns. If the contacts of the welding gun wear, the current transfer between the welding gun is no longer optimal, such that an excessively low current flow and an excessive short welding time have the effect that the resistance spot welds produced do not have the necessary strength. This can have the effect that the workpieces produced with the low-quality spot welds (for example the bodies of vehicles) do not have the necessary stability in the event of a collision, such that legal safety requirements are not met. In the worst-case scenario, this has the consequence for the vehicle manufacturer of a high level of compensation being claimed.

Therefore, the object of the present invention is to provide a method and a control device for monitoring and/or regulating the quality of spot welds of a resistance welding gun in order to classify, regulate and document the quality of a resistance spot weld produced.

This object is achieved by means of a method in accordance with claim 1 and a control device in accordance with claim 10.

The present invention provides a method for monitoring the quality of spot welds of a resistance welding gun, wherein the method comprises the following steps:
measuring and storing measured values during the execution of resistance spot welds at different locations on a workpiece, wherein the measured values represent a voltage, a current, a resistance, a welding time, an energy, a force on welding contacts and/or a power during the production of a resistance spot weld;
comparing the measured values with a reference measurement value, wherein the reference measurement value represents a corresponding voltage, a current, a resistance, a welding time, an energy, a force on welding contacts and/or a power during the production of a corresponding reference resistance spot weld; and
outputting a warning message if, in the step of comparing, it is ascertained that a predetermined number of successive measured values lie outside a predefined tolerance band from the reference value.

Furthermore, the present invention provides a control device designed for executing steps of the method mentioned above.

The present invention is based on the insight that it is possible to achieve an improvement in the quality to be produced for a resistance spot weld by virtue of the fact that, in the course of applying the resistance spot welds, specific physical variables are measured and are compared with reference variables. If the measured variables lie outside a tolerance range of, for example, 70% above or below the reference value, such a deviation is registered and the deviation is stored. If such a deviation from the reference value then occurs again in a subsequent resistance spot weld or the measured value thereof, said deviation is in turn registered and stored. The measurement following that is again analogously compared with the reference value and stored. If it is then ascertained in the course of storage that a specific number of (successive) measured values all lying outside the tolerance range around the reference value are present, the warning message is output. This makes it possible to ensure that, in the case of an excessively poor quality of the resistance spot welds, a warning is output and a measure for improving the quality of the spot welds is implemented in order to ensure that the quality of further resistance spot welds again lies in the tolerance range around a reference measurement value. The quality of each resistance spot weld can also recorded in a simple manner, such that uninterrupted documentation is available even in the event of damage.

Such an approach for checking and/or regulating the quality of a resistance spot weld affords the advantage that the automatic detection makes it possible to identify very rapidly and exactly whether the corresponding resistance spot weld corresponds to a predetermined quality criterion (which is represented by the reference measurement value). If this is not the case, it is possible, as a result of the warning message that has been output, for a relevant resistance spot weld to be manually reworked in order to achieve the required quality criterion. As a result of the definition of the predetermined number of measured values (for example 3 to 5 measured values), which lie outside the predefined tolerance band from the reference value, and which has to be attained in order to output the warning message stated, it is possible to ensure that an individually occurring disturbance is not interpreted as wear-dictated changes in the resistance welding gun. This ensures that the warning message is output only when wear of the welding gun or a system-dictated change in the welding environment actually occurs which tends to lead to weak spot welds and should therefore be identified. Furthermore, the proposed approach affords the possibility, in principle, of storing, for each resistance spot weld, the detected measured value for each workpiece and thus of enabling uninterrupted quality control of the resistance spot weld. This makes it possible in a simple manner for a user of the proposed approach to demonstrate, in the event of compensation being claimed, that there was no fault on a workpiece welded during its operation.

In accordance with one particular embodiment of the present invention, the method can furthermore comprise a step of assessing the quality of a resistance spot weld, wherein, for assessing the quality, a temporal resistance profile in the case of the resistance spot weld is compared with a temporal resistance profile in the case of a reference resistance spot weld and the quality of the resistance spot weld is effected on the basis of an evaluation of whether the temporal resistance profile of the resistance spot weld is outside a tolerance range around the temporal resistance profile in the case of the reference resistance spot weld or whether a derivative of the temporal resistance profile of the resistance spot weld at a predefined point in time lies outside a tolerance zone around a derivative at the predefined point in time into the temporal resistance profile of the reference resistance spot weld. In this case, the method, in the step of outputting, can furthermore output a warning message when, in the step of assessing the quality of the resistance spot weld, it was ascertained that a predetermined number of successively executed resistance spot welds have a temporal resistance profile lying at at least one point in time outside the tolerance range around the temporal resistance profile of the reference resistance spot weld at the corresponding point in time. Such an embodiment of the present invention affords the advantage that use is made not just of an individual (point-type) measured value for assessing the quality of a resistance spot weld, but rather of a (longer) temporal profile of the resistance during welding. From this it is possible to discern, using the temporal resistance profile of a welding of a reference spot, whether the welding of the spot weld of the measured value likewise corresponds to the high quality requirements. In this way, the warning message can be output, in particular, when the risk of wear also becomes clearly discernable as a result of the temporal sequence of the resistance welding using the resistance welding gun.

In accordance with another embodiment of the present invention, the steps of the method can be executed for each resistance spot weld carried out by the resistance welding gun. Such an embodiment of the present invention affords the advantage that it is possible to continuously monitor the quality of each spot weld which is executed by the corresponding resistance welding gun. This enables particularly detailed documentation of the quality of the spot welds which are applied on a workpiece.

It is also favorable if the method furthermore comprises a step of resistance spot welding, wherein, during the step of resistance spot welding, a change in the resistance welding time, the resistance welding current intensity and/or the resistance welding voltage at the resistance welding gun relative to a previously executed resistance spot weld is effected in such a way that the measured value for a weld executed in the step of resistance spot welding again lies within the tolerance range around the reference measurement value. Such an embodiment of the present invention affords the advantage that correction of possibly erroneous parameter settings of the resistance welding gun is possible in the step of resistance spot welding, such that the spot welds produced again yield measured values lying within the tolerance range around the reference value. In this way, by way of example, wear of the resistance welding gun can be compensated for by the welding current or welding time being increased, such that the quality or strength of the spot weld produced can be improved.

Furthermore, in accordance with another embodiment of the present invention, for the step of outputting the warning message, in the case of a change of the workpiece to be provided with resistance spot welds, a counter for counting successively occurring measured values lying outside the tolerance range around the reference value can be reset. Such an embodiment of the invention affords the advantage that the faults or qualitatively poor resistance spot welds per workpiece can be identified, counted and documented, such that a component-related evaluation of the quality of the resistance spot welds can be realized.

It is also possible for the measured values from each resistance spot weld for each workpiece to be furthermore stored in a central memory. This facilitates the presentation of evidence in the event of a complaint about a defective workpiece, since, in such an embodiment of the invention, the quality of each spot weld can be exactly documented and retrieved from the central memory or computer.

It is also favorable if, in the method in accordance with a further embodiment of the invention, a step of executing a reference measurement is furthermore provided, wherein the corresponding reference value is recorded and stored for the subsequent comparison with the measured values. This affords the advantage that it is possible individually to detect the reference value for a resistance welding gun, such that intrinsic characteristics of the resistance welding gun respectively used can be taken into account.

In another embodiment of the invention, the method can furthermore comprise a step of changing the resistance welding gun, wherein the step of executing a reference measurement is effected after the step of changing the resistance gun. This affords the advantage that there is the possibility of replacing a worn resistance welding gun and calibrating the quality monitoring with regard to the resistance welding gun newly used.

If two components to be welded are bonded with an adhesive material, it is possible, in accordance with another embodiment of the invention, that during a resistance spot weld, firstly a current having a low resistance spot welding current intensity and then a current having a high resistance spot welding current intensity are applied to the resistance welding gun.

This advantageously prevents a situation in which the adhesive, as a result of an excessively high temperature, practically squirts in an uncontrolled manner out of the interspace between the two components to be welded and causes a defective weld as a result of a non-uniform current flow. Rather, by applying a low current intensity, it is possible firstly to implement a slow heating and hence a controlled displacement of the adhesive and subsequently to weld the two affected workpieces together by applying the high current.

### BRIEF DESCRIPTION OF THE DRAWINGS

The invention is explained in greater detail below by way of example with reference to the accompanying drawings, in which:

FIG. 1 shows an illustration of a schematic construction of a resistance welding gun for a workpiece to be welded;

FIG. 2 shows an exemplary illustration of the assessment of the quality of a resistance spot weld produced by means of the comparison of measured values with a reference measurement value;

FIG. 3 shows an exemplary illustration of an assessment of a a measured value using a temporal resistance profile in the case of a reference spot weld;

FIG. 4 shows a schematic illustration of a temporal profile when a current is applied to the resistance welding gun if an adhesive material has been applied between the workpieces to be welded; and

FIG. 5 shows a flowchart of an exemplary embodiment of the present invention as a method.

Identical or similar elements can be provided by identical or similar reference signs in the following figures. Furthermore, the figures of the drawings, the description thereof and also the claims contain numerous features in combination. It is clear to a person skilled in the art here that these features can also be considered individually or they can be combined to form further combinations not explicitly described here. The sizes and dimensions mentioned below serve merely for illustration purposes and should not be provided to the effect that they restrict the invention to these sizes and dimensions.

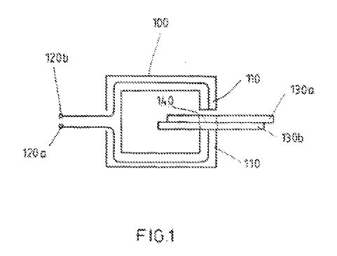

In order to carry out as many welds as possible as rapidly as possible, modern manufacturing plants often use welding robots which can apply a multiplicity of spot welds to workpieces using welding guns in a short time. Such a welding gun 100 is illustrated by way of example in FIG. 1, wherein, in particular, the welding contacts 110 at the welding gun tip are crucial for a particularly good quality of the spot weld. This is because if an electric current is fed in at the contact-making connections 120a and 120b of the welding gun 100, said electric current flows via the contact tips 110 of the welding gun 100 into the workpieces 130a and 130b to be joined (which are metal sheets, for example), such that, as a result of the high current flow, said workpieces locally melt and are joined in this case in the form of a spot weld 140.

In the case of worn or otherwise damaged welding contacts 110 of the of the welding gun 100, however, it is not possible to produce a spot weld 140 having the desired quality, since, for example, a current density is too low or too high, or a contact area of the contact 110 with the corresponding workpieces 130a and 130b is too small, such that the spot weld does not have the required size or uniformity. However, a poor quality of the spot weld 140 has the effect that the two workpieces 130a and 130b are not bonded sufficiently firmly with a. If, for example, the two workpieces 130a and 130b are metal sheets of a vehicle body to be produced, spot welds having a deficient quality can have the effect that the vehicle body does not have the stiffness prescribed for legally prescribed accident tests. If a vehicle body having the defective spot welds were nevertheless delivered and if a vehicle having such a body were involved in an accident in which persons are harmed, the manufacturer of the vehicle body would, under certain circumstances, have to pay compensation.

For this reason, it is firstly necessary that the spot welds which are to be applied to workpieces are firstly monitored with regard to their quality and, secondly, this quality is as far as possible also documented in order, in possible compensation proceedings, to have legally sufficient proof of the fault-free nature or sufficient quality of the workpiece produced.

The approach according to the invention as proposed here intervenes at this point.

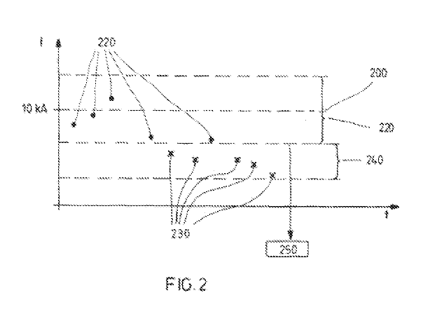

According to the invention, it is firstly assumed that a current, a voltage, a resistance, a welding time, an energy and/or a power during the production of a resistance spot weld using the welding gun are/is recorded in a reference measurement. In this case, it is assumed that the quality of the spot weld is optimal in the case of the reference measurement and can be used as an appraisal criterion for further measurements on spot welds carried out. By way of example, it is possible to set a spot weld for the the reference measurement with a specific current intensity of 10 kA, such that it has a good quality. This current intensity of 10 kA then forms a reference value 200, as is illustrated for example in FIG. 2. Around said reference value 200 it is possible to place a tolerance range 210 that includes, for example, a deviation of +/−30% from said reference value 200, such that in the case of a spot weld which was manufactured with a current intensity value in this tolerance range can also be assessed as a spot weld having good quality. This reference value 200 and the tolerance range 210 are then used to assess in the measurements of the spot welds applied to the workpieces in the work sequence at different points in time t.

If, in the work sequence, the welding gun 100 produces spot welds whose measured values 220 in terms of the current intensity, for example, lie within the tolerance range 210 around the reference value 200, a sufficiently good quality of said spot welds 220 can thus be assumed, such that no further inspection or rework is necessary at these spot welds. However, if the welding contacts 110 of the welding gun 100 wear, current can no longer be sufficiently transferred into the workpieces 130 as a result of the smaller contact area, for example, and so the measured values 230 for such spot welds lie in a range 240 outside the tolerance range 210. However, an individual measured value 230 in the range 240 outside the tolerance range 210 can also occur as a result of a singular disturbance in the course of setting the spot weld, such that there is no process abnormality in this case. However, if a plurality of successive measured values 230 lie in the range 240 outside the tolerance range 210, it should be assumed that a system-dictated fault has occurred in the course of applying the resistance spot weld, said fault being caused for example by the wear of the contacts 110 of the welding gun 100. This adversely affects the process stability of the welding method. However, other permanent disturbances can also lead to the occurrence of measured values 230 in the range 240 which impairs the quality of the corresponding spot welds.

If a sequence of successive measured values 230 is identified which is longer than a predetermined number (for example 3 to 5), a systematic impairment of the quality of spot welds is identified, which leads to the warning message 250 being output. In this way, the quality of spot welds of a resistance welding gun 100 can be monitored in a simple manner, such that, if appropriate, in a timely manner, the welding contacts 110 can be changed or the welding gun 100 can be replaced. At the same time, however, it is also possible to store the measured values 220 or 230 for each spot weld, such that an uninterrupted automatic documentation of the spot welds applied by means of the welding gun 100 is possible. Furthermore, as a result of the evaluation of such documentation, it is also possible to manually rework those spot welds whose measured values 230 lie outside the tolerance range 210. This gives rise to the possibility of being able to localize in a simple manner even individual spot welds having poor quality on the workpieces by means of the automated detection of the measured values.

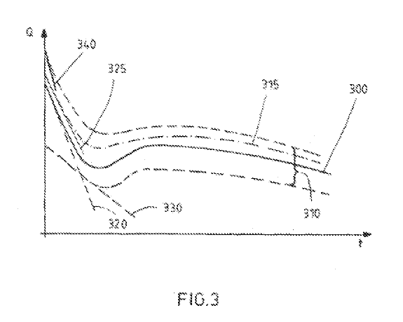

However, the quality of a spot weld can also be assessed by evaluation of the temporal resistance profile during the welding of the spot weld. For this purpose, the resistance profile is recorded during the welding of the reference spot weld, as is illustrated by the line 300 for example in FIG. 3. In this case, it is in turn possible to take account of a tolerance range 310 around this reference resistance profile 300, such that the quality of a spot weld can be identified as sufficient if, during the welding process for a spot weld to be assessed, the measured temporal resistance profile 315 during the production of the corresponding spot weld does not lie outside said tolerance range 310. Alternatively, a derivative 320 of the reference measurement value 300 can also be compared with a derivative 325 of a temporal resistance profile 315 of the spot weld to be assessed, wherein the spot weld can then be assessed as qualitatively sufficient if the derivative has a gradient lying within a gradient range represented for example by the gradient characteristic curves 330 and 340 illustrated in FIG. 3.

In order to achieve an improvement in the quality of the spot welds, it is also possible to effect an adaptation of parameters during the welding process. By way of example, a current intensity or a welding time can be increased if measured values 230 occur which lie outside the tolerance range 210.

### Process Stability PSF

It is therefore possible to determine a process stability factor that expresses the process stability of the spot welding process in the manner of the extent to which the weld indicated by the measured value corresponds to the reference weld. A process stability value of 100% means full correspondance of the process to the process of the reference weld and thus signals a welding process which is stable in an unchanged fashion. Thus, by way of example, a process stability of 70% states that the welding process has changed by 30% in comparison with the reference weld. On the welding device (or welding gun), a change can arise, e.g. as a result of wear, which can then be identified by means of the process factor. Alternatively, a disturbance variable was present, which the U/I regulator had to compensate for in order to improve the welding quality. Disturbance variables, if they occur once, are characterized by a single deviation from the 100% line, e.g. in the case of spatter or in the case of an edge weld. Continuously increasing deviations indicate wear, usually from the electrode caps of the welding gun.

In this case, the value of the process stability factor (PSF value) is a variable without units which is calculated and normalized by the welding regulator firmware. It describes the stability of a welding process for a spot weld.

In this case, high values (for example the maximum value is 100) represent very stable and reliable processes. No or only very little regulating intervention takes place in processes with such values. In this case, the present resistance curve is virtually congruent with the reference resistance curve of the respectively welded spot.

Low values (for example the minimum value is 0) represent highly unstable and unreliable processes. In this case, high regulating intervention (large welding time and/or current changes) can take place in processes having such values. These can, even despite unfavorable boundary conditions, ensure a good spot weld.

The calculation of the PSF value is based on an algorithm stored in the firmware of the regulator. Input variables for the calculation of this value are measured and calculated electrical characteristic variables such as current, voltage, resistance, phase gating, power, energy input, but also characteristic variables that describe the profile of the presently measured resistance curve (minima, maxima, gradients).

The comparison of the progressing process with the (learned) reference yields a measure of the state and the reliability of the welding process and of the welding device (trend analysis).

If disturbance variables have to be compensated for by a current time lengthening, then this process change is manifested in an impairment of the process stability value. At the same time, the monitoring parameter current time indicates a higher value. In the case of handheld guns it should be taken into consideration that the welding of different sheet metal combinations actually also represents disturbance variables in comparison with the reference weld. That also leads to deviations in the process stability in the case of correspondingly different material.

In CCR/PHA operation, the process stability is only indicated if a reference curve was loaded.

### Process Quality UIP

The process quality results from the exact analysis of the resistance profile of a weld, as illustrated for example in FIG. 3. Significant vertices and trends of the curve profile are used for the calculation. For this purpose, the resistance profile is subdivided into a plurality of sections. Significant points of the resistance profile are deemed to include the initial and end resistance, and the local maximum and minimum. Gradients and tendencies that permit a statement about the welding quality are derived between these points. The results of the UIP calculation of the individual sections are included in the UIP with different degrees of weighting, depending on which section is involved. Since the dynamic range of the resistance profile is only weakly pronounced for some welding tasks, a comparison with the corresponding sections of the reference profile is additionally established and included in the calculation. The quality statement in the case of handheld guns is more difficult to interpret if different materials and sheet metal thicknesses are processed by means of a program.

In this case, a process quality factor (also called UIP value) can be a variable without unit which is calculated and normalized by the regulator firmware. It describes the “theoretically calculated” quality of a spot weld, independently of whether this quality was achieved without or with a compensating regulating intervention.

In this case, high UIP values (i.e. in particular greater than 100) predict on the basis of the calculation spot welds having a sufficient and good lens diameter corresponding at least to the originally learned spot diameter.

Low UIP values (wherein the minimum value is 0) predict (even despite regulating intervention) an inadequate spot diameter or even an unattached spot weld. The calculation of the UIP value is based on an algorithm stored in the firmware of the regulator. Input variables for the calculation of this value are measured and calculated electrical characteristic variables such as current, voltage, resistance, phase gating, power, energy input, but also characteristic variables that describe the profile of the presently measured resistance curve (minima, maxima, gradients) and thus also the quality of the weld.

In CCR/PHA operation the process quality is only indicated if a reference curve was loaded.

### Tolerances

In order to determine tolerance bands for monitoring, the following procedure is proposed:

Firstly, the actual values from the reference weld are adopted as reference for monitoring. An image of the limits within which the monitored variable varies emerges from the indicated profile of a monitored variable. The tolerances are best placed around the reference value such that most welds lie in the “good range”. Thus, outliers then lie outside the tolerance bands. Care should be taken to ensure that normal manufacturing fluctuations do not lie outside the tolerance limits (e.g. as a result of low electrode wear, milling). In the indication of the profile, the programmed tolerances are indicated as lines and clearly show how the tolerance bands would have an effect.

After possibly further observation and optimization, it is possible to activate the monitoring for this variable. In addition, it is necessary to check that the monitoring is also switched on for this program and “generally”. The tolerances are best programmed at an operating interface in the order

1. permissible tolerance band at the top,

2. tolerance band permissible to a limited extent

3. permissible tolerance band at the bottom.

It is thus possible to determine a process stability factor which demonstrates the process stability of the welding process and also enables or demonstrates interventions of a corresponding regulator. In conjunction with a process history that was stored, a change in the process situation can be discerned, as a result of which a trend analysis of the process is made possible. In this case, a comparison is determined from a reference weld and a present weld.

In addition, a quality factor can be determined by determining a comparison of the resistance profiles in the present weld with the reference weld.

The function presented thus enables systematic fault identification, as a result of which a high quality and production standard is ensured. In particular, it is possible to ensure a permanent process spot welding quality in series production, as a result of which the production conditions are significantly improved. At the same time, it is possible to set the counting of the measured values that have occurred outside a permissible tolerance range in such a way that this counter is reset for each workpiece to be welded such that a component-related quality warning message can be output. Alternatively, it is also possible to output a manufacturing-program-related warning message in order to determine long-term wear of the welding gun. The proposed approach makes it possible to ensure a monitoring function for a complete carcass of the quality of bodies.

### Q Stop Logic

An integrated and parameterizable Q (=quality) stop logic, as it is called, makes it possible to define the conditions for the occurrence of warning messages and stopping a plant. For each of the above-described characteristic values (in particular PSF, UIP) conditional and absolute warning limits are determined and set, the contravention of which leads to a warning message at the plant or to the stopping of a plant:
conditional warning limit:

When the plant is commissioned, the conditional warning limits are set such that the contravention of such a limit does not yet indicate an actually poor spot weld, but rather a worsening process or else the risk of a worsening spot quality. In this case, the process monitoring can be set such that only a repeated (freely parameterizable) contravention of conditional warning limits leads to the stopping of a plant.
absolute warning limit:

By contrast, the contravention of an absolute warning limit indicates a very poor or even open spot weld. In this case, a plant is already stopped upon a single contravention of this limit value. For the contravention of conditional and absolute warning limits, counters exist which are also automatically set to zero again when specific events occur.
component counter:

In this case, only the limit value contraventions within a component are counted. An automatic resetting of the counter for a subsequent component is programmable.
program number counter:

In this case, only limit value contraventions for a specific spot number are counted. This counter, too, can be set automatically to “zero” again depending on a specific number of “good welds” for this program.

The parameterization of conditional and absolute warning limits at the definition of the Q stop or plant stop logic are free and can be performed in accordance with the stipulations for the quality control loops of the production lines of the customer.

Furthermore, there is the possibility, after the welding gun has been changed, to carry out a renewed resistance calibration in order to obtain a new reference value for the spot welds with the new welding gun. In this case, before an assessment of further spot welds with the new welding gun, firstly a reference weld would have to be executed and a corresponding measured value would have to be detected and stored as reference value. The subsequently detected measured values for spot welds are then compared with the new stored reference value and an assessment of the quality of the spot weld produced is carried out taking account of a tolerance range around the new reference value.

In the case of present joining tasks, adhesives are increasingly being used in the joining planes for strength reasons. For this reason, it is also possible to provide a function in order to provide a new gun control for welding guns for the production of welding connections with adhesive between the metal sheets to be welded, since this type of connections is increasing more and more in bodywork construction. For the functioning of the following description it is unimportant which type of adhesive, that is to say sealing adhesive or bonding adhesive, is used. From a purely physical standpoint, the adhesive between the metal sheets represents an insulator that does not permit a current flow. Therefore, the function always requires a shunt whose current flow brings about heating and which therefore provides for the displacement of the adhesive in the spot weld. Conductive adhesives form exceptions here, although use of this function is also expedient in the case of said conductive adhesives.

Consequently adhesive acts as an insulator between the metal sheets. The welding current flows away via shunts at the beginning of the weld and is absent in the production of the actual spot weld. Depending on the type of adhesive, thickness of the adhesive application, viscosity of the adhesive, the time until the adhesive is displaced by the formation of heat, that is to say the welding current flows through the actual spot weld, can vary greatly. Therefore, it is not possible to ensure a uniform welding quality. Since the normal welding sequence is conducted using the parameterized welding current, which is generally between 7 kA and 12 kA, the adhesive is displaced very rapidly as a result of the high formation of heat. This occurs partly in an explosive fashion. Since the gun cannot follow this change so rapidly at all, the process reaction is often very violent, and spatter and burnt spots occur.

The aim of the function presented here should be to displace the adhesive “gently” and, when a defined metal sheet-metal sheet contact is present, to start the actual welding sequence. In this case, the regulator should adapt optimally to the breakthrough time of the adhesive.

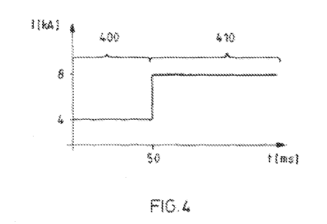

In order to be able to utilize the function, the following procedure is expedient, which is illustrated in greater detail in FIG. 4. Firstly, a low current intensity should be applied to the welding gun. Here it is expedient for instance to use a current intensity of approximately half of the actual welding current, that is to say approximately 4-5 kA. With this first phase 400 of welding, the intention is only to heat the region around the spot weld to be produced and to displace the adhesive. The two components are not yet intended to be welded. The length of the first phase should be determined such that the adhesive can be displaced. 50 ms to 80 ms should be sufficient here.

The parameterization of the second phase 410 should be designed in the manner that would be necessary for the welding task without adhesive. The actual welding is intended to take place in this phase. In this way, the quality of the spot welds can furthermore be increased if an adhesive material connects the components to be welded prior to welding.

The force with which the contacts of the resistance welding gun are pressed onto the workpiece can also be monitored. This furthermore enables a conclusion to be drawn about the wear of the contacts 110 of the resistance welding gun, since, in the case of worn contact tips, said contact tips have to be moved over a longer distance until the desired pressure of the contacts on the workpiece is established. To put it another way, the determination of a force with which the contacts press onto the workpiece can give an indication of how good the current connection between contacts and workpiece is and how good, therefore, the quality of the weld can consequently be. Documentation or storage or assessment of this force in accordance with the abovementioned assessment method using a tolerance range can then likewise be used for assessing the quality of the.

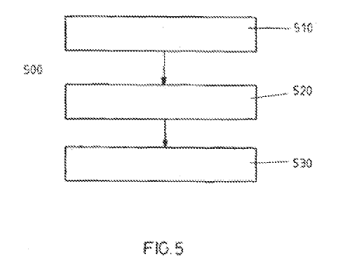

For the sake of completeness, it should be noted that the present invention also encompasses a method 500 for monitoring and/or regulating the quality of spot welds of a resistance welding gun, as illustrated in FIG. 5, wherein the method 500 comprises a first step of measuring 510 and storing measured values during the execution of resistance spot welds at different locations of a workpiece, wherein the measured values represent a voltage, a current, a resistance, a welding time, an energy and/or a power during the production of a resistance spot weld. Furthermore, the method comprises a step of comparing 520 the measured values with reference measurement value, wherein the reference measurement value represents a corresponding voltage, a current, a resistance, a welding time, an energy and/or a power during the production of a corresponding resistance spot weld. Finally, the method 500 comprises a step of outputting 530 a warning message if, in the step of comparing 520 it is ascertained that a predetermined number of successive measured values lie outside a predefined tolerance band from the reference value.

Consequently, the invention presented above enables a generally applicable quality assurance concept for resistance spot welding which becomes possible by means of regulation, monitoring and assessment of spot welded joints. In this case, the proposed approach is integrated into an overall concept with integrated regulating and monitoring concept with integrated process monitoring and quality assessment. A method for efficient production progression with simultaneous validation of the spot welding quality is ensured at the same time.

Given suitable programming of the warning limits and of the integrated Q stop logic, automatic and 100% process and quality assessment of all the spot welds produced within the production line is possible. In comparison with previous manual testing by random sampling (for example by means of ultrasound or destructive testing), systematic faults are identified significantly earlier. Even individual faults are indicated given suitably chosen warning limits. With the consistent utilization of this process and quality monitoring, the time-consuming and manual ultrasonic testing or destructive testing of spot welds as carried out hitherto is significantly reduced. The personnel requirement for manual tests of products of a product line can thus be reduced by approximately 50% in a first step, and further reductions are possible through optimizations. This objective type of monitoring makes it possible to carry out an assessment of process and quality which is human-independent and accurately repeatable.

### LIST OF REFERENCE SYMBOLS

100 Resistance welding gun

110 Welding contacts of the resistance welding gun 100

120a, 120b Power supply contacts of the resistance welding gun 100

130a, 130b Components of a workpiece that are to be welded

140 Spot weld

200 Reference measurement value

210 Tolerance range around the reference measurement value

220 Measured values in the tolerance range 210 around the reference measurement value 200

230 Measured values outside the tolerance range 210 around the reference measurement value 200

250 Warning message

300 Temporal resistance profile during the execution of a reference weld

310 Tolerance range around the temporal resistance profile during the execution of the reference weld

315 Temporal resistance profile during the execution of a spot weld to be measured

320 Derivative of the temporal resistance profile of the reference weld at a predetermined point in time

325 Derivative of a temporal resistance profile of the spot weld to be measured at a predetermined point in time

330, 340 Derivatives for delimiting a derivative tolerance range of the derivative 320 of the temporal resistance profile of the reference weld at a predetermined point in time

400 First phase of the welding with adhesive material

410 Second phase of the welding with adhesive material

500 Method for monitoring and/or regulating the quality of spot welds of a resistance welding gun

510 Measuring and storing measured values during the execution of resistance spot welds

520 Comparing the measured values 220, 230 with the reference measurement value 200

530 Outputting a warning message 250

1. A method for monitoring and/or regulating the quality of spot welds of a resistance welding gun, comprising:
measuring and storing measured values during the execution of resistance spot welds at different locations on a workpiece, wherein the measured values represent a voltage, a current, a resistance, a welding time, an energy, a force on welding contacts, and/or a power during the production of a resistance spot weld;
comparing the measured values with a reference measurement value, wherein the reference measurement value represents a corresponding voltage, a current, a resistance, a welding time, an energy, a force on welding contacts, and/or a power during the production of a corresponding resistance spot weld; and
outputting a warning message if it is ascertained that a predetermined number of successive measured values lie outside a predefined tolerance band from the reference measurement value.

2. The method as claimed in claim 1, further comprising:
assessing the quality of a resistance spot weld,
wherein, for assessing the quality, a temporal resistance profile in the case of the resistance spot weld is compared with a temporal resistance profile in the case of a reference resistance spot weld and the quality of the resistance spot weld is effected on the basis of an evaluation of whether the temporal resistance profile of the resistance spot weld is outside a tolerance range around the temporal resistance profile in the case of the reference resistance spot weld or whether a derivative of the temporal resistance profile of the resistance spot weld at a predefined point in time lies outside a tolerance range around a derivative of the temporal resistance profile of the reference resistance spot weld at the predefined point in time, and
wherein the warning message is outputted when, in assessing the quality of the resistance spot weld, it is ascertained that successively executed resistance spot welds have a temporal resistance profile lying at at least one point in time outside the tolerance range around the temporal resistance profile of the reference resistance spot weld at the corresponding point in time.

3. The method as claimed in claim 1, wherein the method is executed for each resistance spot weld carried out by the resistance welding gun.

4. The method as claimed in claim 1, further comprising:
resistance spot welding,
wherein, during the resistance spot welding, a change in the resistance welding time, the resistance welding current intensity, and/or the resistance welding voltage at the resistance welding gun relative to a previously executed resistance spot weld is effected in such a way that the measured value for a weld executed during the resistance spot welding again lies within the tolerance range around the reference measurement value.

5. The method as claimed in claim 1, wherein, when outputting the warning message, in the case of a change of the workpiece to be provided with resistance spot welds, a counter for counting successively occurring measured values lying outside the tolerance range around the reference value is reset.

6. The method as claimed in claim 1, wherein the measured values from each resistance spot weld for each workpiece are furthermore stored in a central memory.

7. The method as claimed in claim 1, further comprising:
executing a reference measurement,
wherein the corresponding reference measurement value is recorded and stored for the subsequent comparison with the measured values.

8. The method as claimed in claim 7, further comprising:
changing the resistance welding gun,
wherein the executing a reference measurement is effected after the changing the resistance welding gun.

9. The method as claimed in claim 1, wherein:
two components of a workpiece which are to be welded are bonded with an adhesive material, and
during a resistance spot weld, firstly a current having a low resistance spot welding current intensity and then a current having a high resistance spot welding current intensity are fed to the resistance spot welding gun.

10. A control device for monitoring and/or regulating the quality of spot welds of a resistance welding gun, the control device comprising:
a measuring and storing device configured to measure and store measured values during the execution of resistance spot welds at different locations on a workpiece, wherein the measured values represent a voltage, a current, a resistance, a welding time, an energy, a force on welding contacts, and/or a power during the production of a resistance spot weld;
a comparing device configured to compare the measured values with a reference measurement value, wherein the reference measurement value represents a corresponding voltage, a current, a resistance, a welding time, an energy, a force on welding contacts, and/or a power during the production of a corresponding resistance spot weld; and
an outputting device configured to output a warning message if it is ascertained that a predetermined number of successive measured values lie outside a predefined tolerance band from the reference measurement value.
